(19) United States
(12) Patent Application Publication
(10) Pub. No.: US 2026/0181699 A1
(43) Pub. Date: Jun. 25, 2026

(54) RO GROUP FOR MULTIPLE PRACH TRANSMISSIONS

(71) Applicant: Apple Inc., Cupertino, CA (US)

(72) Inventors: Chunhai Yao, Beijing (CN); Chunxuan Ye, San Diego, CA (US); Haitong Sun, Cupertino, CA (US); Hong He, San Jose, CA (US); Seyed Ali Akbar Fakoorian, San Diego, CA (US); Wei Zeng, Saratoga, CA (US); Dawei Zhang, Saratoga, CA (US)

(21) Appl. No.: 18/833,779

(22) PCT Filed: Aug. 9, 2023
(86) PCT No.: PCT/CN2023/111954

§ 371 Date: Jul. 26, 2024

(51) Int. Cl. H04W 74/0833

(52) U.S. Cl. CPC H04W 74/0833

(57) ABSTRACT

Methods, systems, apparatuses, and computer programs for multiple Physical Random Access Channel (PRACH) transmissions are disclosed. In one aspect, operations are performed by a UE and can include identifying the number of RACH occasions (ROs) M associated with a particular Synchronization Signal Block (SSB) in a single SSB-to-RO association pattern period P; obtaining a particular PRACH repetition number N, wherein the particular PRACH repetition number N is equal to or less than a maximum PRACH repetition number L; and determining the number of SSB-to-RO association pattern periods K within a time period X as a function of the number of ROs M associated with the particular SSB in a single SSB-to-RO association pattern period P and the particular PRACH repetition number N.

### BACKGROUND

Wireless communication networks, such as fourth generation (4G), fifth generation (5G), etc., provide integrated communication platforms and telecommunication services to wireless user devices. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time-division multiple access (TDMA) networks, frequency-division multiple access (FDMA) networks, orthogonal frequency-division multiple access (OFDMA) networks, Long Term Evolution (LTE), and Fifth Generation New Radio (5G NR).

Random Access Channel (RACH) Occasion refers to a specific time window within a frame when user devices (UEs) can initiate random access procedures to establish initial communication with the base station. During a RACH Occasion (RO), UEs can transmit random access preambles via the Physical Random Access Channel (PRACH) to request access to the network. The RO defines a time window within which UEs are allowed to transmit their preambles for random access.

### SUMMARY

According to one innovative aspect of the present disclosure, one or more processors of a user equipment (UE) configured to perform operations for multiple Physical Random Access Channel (PRACH) transmissions are disclosed. In one aspect, the operations can include identifying the number of RACH occasions (ROs) M associated with a particular Synchronization Signal Block (SSB) in a single SSB-to-RO association pattern period P; obtaining a particular PRACH repetition number N, wherein the particular PRACH repetition number N is equal to or less than a maximum PRACH repetition number L; and determining the number of SSB-to-RO association pattern periods K within a time period X as a function of the number of ROs M associated with the particular SSB in a single SSB-to-RO association pattern period P and the particular PRACH repetition number N.

Other aspects include methods, apparatuses, systems, and computer programs for performing the aforementioned operations.

The innovative operations can include other optional features. For example, in some implementations,

$$K = \{ \begin{matrix}⌈ \frac{N}{M} ⌉ & if N \geq M \\ 1 & if N < M\end{matrix} and X = K \times P .$$

In some implementations, the operations further include obtaining one or more RO groups within the time period X, wherein at least one RO group is associated with the particular PRACH repetition number N, wherein the number of ROs in the at least one RO group is the same as the particular PRACH repetition number N.

In some implementations, the particular PRACH repetition number N is the maximum PRACH repetition number L, and the operations further include obtaining a single RO group within the time period X, wherein the number of ROs in the single RO group is the maximum PRACH repetition number L.

In some implementations, the particular PRACH repetition number N is ½×the maximum PRACH repetition number L, and the operations further include obtaining two RO groups within the time period X, wherein the number of ROs in each RO group is ½×L.

In some implementations, the particular PRACH repetition number N is ¼×the maximum PRACH repetition number L, and the operations further include obtaining four RO groups within the time period X, wherein the number of ROs in each RO group is ¼×L.

In some implementations, when the single SSB-to-RO association pattern period P includes at least L ROs, K=1.

In some implementations, when K=1, the number of RO groups within the time period X is

$$⌈ \frac{M}{N} ⌉ .$$

In some implementations, the operations further include determining a first starting RO position in a first time period X, wherein the first starting RO position is aligned with a radio frame 0; and determining a second starting RO position in a subsequent time period X, wherein the second starting RO position is the first starting RO position+K×association pattern period×C, where C is a natural number.

In some implementations, the particular PRACH repetition number N is ½×the maximum PRACH repetition number L, and the operations further include providing two RO groups within the time period X, wherein the number of ROs in each RO group is ½×L; and determining a third starting RO position in a second RO group in the first time period X, wherein the third starting RO position is the first starting RO position+½×L×RO.

In some implementations, the particular PRACH repetition number N is ¼×the maximum PRACH repetition number L, and the operations further include providing four RO groups within the time period X, wherein the number of ROs in each RO group is ¼×L; and determining a third starting RO position in a subsequent RO group in the first time period X, wherein the third starting RO position is the first starting RO position+¼×L×RO×m, where m=1, 2, or 3.

In some implementations, the number of SSB-to-RO association pattern periods K is the same for any particular PRACH repetition number.

In some implementations, wherein the number of SSB-to-RO association pattern periods K is associated with the particular PRACH repetition number N, wherein a different N corresponds to a different K.

In some implementations, ROs associated with the particular SSB in each RO group have the same frequency position.

In some implementations, the operations further include obtaining one or more ROs configured with Frequency Division Multiplexing (FDM); and enabling frequency hopping within the ROs configured with FDM.

In some implementations, the number of ROs configured with FDM and associated with the particular SSB is the same at different time instances.

In some implementations, the operations further include dropping a RO having a larger index at a particular time instance, so that the number of ROs configured with FDM and associated with the particular SSB is the same.

According to another innovative aspect of the present disclosure, one or more processors of a user equipment (UE) configured to perform operations for multiple Physical Random Access Channel (PRACH) transmissions are disclosed. In one aspect, the operations can include identifying the number of RACH occasions (ROs) M associated with a particular Synchronization Signal Block (SSB) in a single SSB-to-RO association pattern period P; obtaining a particular PRACH repetition number N, wherein the particular PRACH repetition number N is equal to or less than a maximum PRACH repetition number L; obtaining the number of SSB-to-RO association pattern periods K within a time period X; and determining the number of RO groups Y within the time period X as a function of the number of SSB-to-RO association pattern periods K, the number of ROs M associated with the particular SSB in a single SSB-to-RO association pattern period P and the particular PRACH repetition number N, wherein the number of ROs in each RO group is equal to the particular PRACH repetition number N.

Other aspects include methods, apparatuses, and computer programs for performing the aforementioned operations.

The innovative operations can include other optional features. For example, in some implementations, wherein

$$Y = \{ \begin{matrix}⌈ K / ⌈ \frac{N}{M} ⌉ ⌉ & if N \geq M \\ K * ⌈ \frac{M}{N} ⌉ & if N < M\end{matrix} and X = K \times P .$$

In some implementations, the number of SSB-to-RO association pattern periods K is obtained through Radio Resource Control (RRC) signaling or System Information Block 1 (SIB1).

In some implementations, the particular PRACH repetition number N is ½×the maximum PRACH repetition number L, and the operations further include determining the number of RO groups 2×Y within the time period X, wherein the number of ROs in each RO group is ½×L.

In some implementations, the particular PRACH repetition number N is ¼×the maximum PRACH repetition number L, and the operations further include determining the number of RO groups 4×Y within the time period X, wherein the number of ROs in each RO group is ¼×L.

In some implementations, the operations further include determining a first starting RO position of a first RO group in the time period X, wherein the first starting RO position is aligned with a radio frame 0; and determining a subsequent starting RO position of a subsequent RO group in the time period X, wherein the subsequent starting RO position is the first starting RO+Z×y, where y≤Y and y is a natural number, and

$$Z = \{ \begin{matrix}⌈ \frac{N}{M} ⌉ & if N \geq M \\ ⌈ \frac{M}{N} ⌉ & if N < M\end{matrix} .$$

In some implementations, the number of SSB-to-RO association pattern periods K is the same for any particular PRACH repetition number.

In some implementations, the number of SSB-to-RO association pattern periods K is associated with the particular PRACH repetition number N, wherein a different N corresponds to a different K.

In some implementations, associated with the particular SSB in each RO group have the same frequency position.

In some implementations, the operations further include obtaining one or more ROs configured with Frequency Division Multiplexing (FDM); and enabling frequency hopping within the ROs configured with FDM.

In some implementations, the number of ROs configured with FDM and associated with the particular SSB is the same at different time instances.

In some implementations, the operations further include dropping a RO having a larger index at a particular time instance, so that the number of ROs configured with FDM and associated with the particular SSB is the same.

In some implementations, the operations further include performing a density control of RO groups.

In some implementations, the operations further include selecting only a first RO group within the time period X used for multiple repetitions of PRACH transmission.

In some implementations, the operations further include providing a bitmap indicating one or more RO groups within the time period X used for multiple repetitions of PRACH transmission.

In some implementations, the operations further include obtaining a ratio of the RO groups within the time period X used for multiple repetitions of PRACH transmission.

In some implementations, the operations further include obtaining one or more odd RO groups or one or more even RO groups within the time period X used for multiple repetitions of PRACH transmission.

In some implementations,

$$Y = ⌈ K * \frac{M}{N} ⌉ .$$

According to another innovative aspect of the present disclosure, one or more processors of a base station configured to perform operations for multiple Physical Random Access Channel (PRACH) transmissions are disclosed. In one aspect, the operations can include identifying the number of RACH occasions (ROs) M associated with a particular Synchronization Signal Block (SSB) in a single SSB-to-RO association pattern period P; configuring a particular PRACH repetition number N, wherein the particular PRACH repetition number N is equal to or less than a maximum PRACH repetition number L; and determining the number of SSB-to-RO association pattern periods K within a time period X as a function of the number of ROs M and the particular PRACH repetition number N.

Other aspects include methods, apparatuses, systems, and computer programs for performing the aforementioned operations.

The innovative operations can include other optional features. For example, in some implementations,

$$K = \{ \begin{matrix}⌈ \frac{N}{M} ⌉ & if N \geq M \\ 1 & if N < M\end{matrix} and X = K \times P .$$

In some implementations, the operations further include configuring one or more RO groups within the time period X, wherein at least one RO group is associated with the particular PRACH repetition number N, wherein the number of ROs in the at least one RO group is the same as the particular PRACH repetition number N.

In some implementations, the particular PRACH repetition number N is the maximum PRACH repetition number L, and the operations further include configuring a single RO group within the time period X, wherein the number of ROs in the single RO group is the maximum PRACH repetition number L.

In some implementations, the particular PRACH repetition number N is ½×the maximum PRACH repetition number L, and the operations further include configuring two RO groups within the time period X, wherein the number of ROs in each RO group is ½×L.

In some implementations, the particular PRACH repetition number N is ¼×the maximum PRACH repetition number L, and the operations further include configuring four RO groups within the time period X, wherein the number of ROs in each RO group is ¼×L.

In some implementations, when the single SSB-to-RO association pattern period P includes at least L ROs, K=1.

In some implementations, when K=1, the number of RO groups within the time period X is

$$⌈ \frac{M}{N} ⌉ .$$

In some implementations, the operations further include determining a first starting RO position in a first time period X, wherein the first starting RO position is aligned with a radio frame 0; and determining a second starting RO position in a subsequent time period X, wherein the second starting RO position is the first starting RO position+K×association pattern period×C, where C is a natural number.

In some implementations, the particular PRACH repetition number N is ½×the maximum PRACH repetition number L, and the operations further include providing two RO groups within the time period X, wherein the number of ROs in each RO group is ½×L; and determining a third starting RO position in a second RO group in the first time period X, wherein the third starting RO position is the first starting RO position+½×L×RO.

In some implementations, the particular PRACH repetition number N is ¼×the maximum PRACH repetition number L, and the operations further include providing four RO groups within the time period X, wherein the number of ROs in each RO group is ¼×L; and determining a third starting RO position in a subsequent RO group in the first time period X, wherein the third starting RO position is the first starting RO position+¼×L×RO×m, where m=1, 2, or 3.

In some implementations, the number of SSB-to-RO association pattern periods K is the same for any particular PRACH repetition number.

In some implementations, the number of SSB-to-RO association pattern periods K is associated with the particular PRACH repetition number N, wherein a different N corresponds to a different K.

In some implementations, ROs associated with the particular SSB in each RO group have the same frequency position.

In some implementations, the operations further include configuring one or more ROs with Frequency Division Multiplexing (FDM); and enabling frequency hopping within the ROs configured with FDM.

In some implementations, wherein the number of ROs configured with FDM and associated with the particular SSB is the same at different time instances. In some implementations, the operations further include dropping a RO having a larger index at a particular time instance, so that the number of ROs configured with FDM and associated with the particular SSB is the same.

According to another innovative aspect of the present disclosure, one or more processors of a base station configured to perform operations for multiple Physical Random Access Channel (PRACH) transmissions are disclosed. In one aspect, the operations can include identifying the number of RACH occasions (ROs) M associated with a particular Synchronization Signal Block (SSB) in a single SSB-to-RO association pattern period P; configuring a particular PRACH repetition number N, wherein the particular PRACH repetition number N is equal to or less than a maximum PRACH repetition number L; configuring the number of SSB-to-RO association pattern periods K within a time period X; and determining the number of RO groups Y within the time period X as a function of the number of SSB-to-RO association pattern periods K, the number of ROs M associated with the particular SSB in a single SSB-to-RO association pattern period P and the particular PRACH repetition number N, wherein the number of ROs in each RO group is equal to the particular PRACH repetition number N.

Other aspects include methods, apparatuses, and computer programs for performing the aforementioned operations.

The innovative operations can include other optional features. For example, in some implementations,

$$Y = \{ \begin{matrix}⌈ K / ⌈ \frac{N}{M} ⌉ ⌉ & if N \geq M \\ K * ⌈ \frac{M}{N} ⌉ & if N < M\end{matrix} and X = K \times P .$$

In some implementations, the number of SSB-to-RO association pattern periods K is configured through Radio Resource Control (RRC) signaling or System Information Block 1 (SIB1).

In some implementations, the particular PRACH repetition number N is ½×the maximum PRACH repetition number L, and the operations further include determining the number of RO groups 2×Y within the time period X, wherein the number of ROs in each RO group is ½×L.

In some implementations, the particular PRACH repetition number N is ¼×the maximum PRACH repetition number L, the operations further include determining the number of RO groups 4×Y within the time period X, wherein the number of ROs in each RO group is ¼×L.

In some implementations, the operations further include determining a first starting RO position of a first RO group in the time period X, wherein the first starting RO position is aligned with a radio frame 0; and determining a subsequent starting RO position of a subsequent RO group in the time period X, wherein the subsequent starting RO position is the first starting RO+Z x y, where y≤Y and y is a natural number, and

$$Z = \{ \begin{matrix}⌈ \frac{N}{M} ⌉ & if N \geq M \\ ⌈ \frac{M}{N} ⌉ & if N < M\end{matrix} .$$

In some implementations, the number of SSB-to-RO association pattern periods K is the same for any particular PRACH repetition number.

In some implementations, the number of SSB-to-RO association pattern periods K is associated with the particular PRACH repetition number N, wherein a different N corresponds to a different K.

In some implementations, ROs associated with the particular SSB in each RO group have the same frequency position.

In some implementations, the operations further include configuring one or more ROs with Frequency Division Multiplexing (FDM); and enabling frequency hopping within the ROs configured with FDM.

In some implementations, the number of ROs configured with FDM and associated with the particular SSB is the same at different time instances.

In some implementations, the operations further include dropping a RO having a larger index at a particular time instance, so that the number of ROs configured with FDM and associated with the particular SSB is the same.

In some implementations, the operations further include performing a density control of RO groups.

In some implementations, the operations further include selecting only a first RO group within the time period X used for multiple repetitions of PRACH transmission.

In some implementations, the operations further include providing a bitmap indicating one or more RO groups within the time period X used for multiple repetitions of PRACH transmission.

In some implementations, the operations further include configuring a ratio of the RO groups within the time period X used for multiple repetitions of PRACH transmission.

In some implementations, the operations further include configuring one or more odd RO groups or one or more even RO groups within the time period X used for multiple repetitions of PRACH transmission.

In some implementations,

$$Y = ⌈ K * \frac{M}{N} ⌉ .$$

### BRIEF DESCRIPTION OF THE DRAWINGS

FIG. 1 illustrates an example wireless network, according to some implementations.

FIG. 2 illustrates an example process of determining a time period X and one or more RO groups within the time period X, according to some implementations.

FIG. 3 illustrates a single time period X applied to all PRACH repetition levels, according to some implementations.

FIGS. 4A-4C illustrate a frequency position of ROs associated with the same SSB in each RO group, according to some implementations.

FIGS. 5A-5C illustrate a different repetition level corresponding to a different time period, according to some implementations.

FIG. 6 illustrates multiple RO groups within a time period X for a maximum repetition level, according to some implementations.

FIG. 7 illustrates an example process of determining a time period X and multiple RO groups within the time period X, according to some implementations.

FIG. 8 illustrates another example process of determining a time period X and one or more RO groups within the time period X, according to some implementations.

FIG. 9 illustrates another example process of determining a time period X and multiple RO groups within the time period X, according to some implementations.

FIG. 10 is a block diagram of an example UE, according to some implementations.

FIG. 11 is a block diagram of an example access node, according to some implementations.

Like reference symbols in the various drawings indicate like elements.

### DETAILED DESCRIPTION

This disclosure describes methods and systems for multiple Physical Random Access Channel (PRACH) transmissions, used for determining a time period X including K Synchronization Signal Block-to-RACH Occasion (SSB-to-RO) association pattern periods and one or more RO groups (time position and frequency position of the one or more RO groups) within the time period X. The methods and systems can be implemented by either a user equipment (UE) or a base station.

In some implementations of these methods and systems, the time period X can be implicitly determined based on the number of ROs M associated with the particular SSB in a single SSB-to-RO association pattern period P and a particular PRACH repetition number N. In some implementations, the number of association pattern periods K within the time period X (X=K×P) is explicitly configured by the base station. The number of RO groups Y within the time period X is determined based on the number of SSB-to-RO association pattern periods K, the number of ROs M associated with the particular SSB in a single SSB-to-RO association pattern period P, and the particular PRACH repetition number N. The number of ROs in each RO group is equal to the particular PRACH repetition number N.

In some implementations, the PRACH repetition number N can be 8, 4, or 2. In some implementations, the time period X can apply to all PRACH repetition levels or numbers (the PRACH repetition number N is 8, 4, or 2). Regardless of a value of the PRACH repetition number N, the time period X is the same. In some implementations, the time period X may be different for each PRACH repetition number N. For example, a first time period X1 corresponds to N=8. A second time period X2 corresponds to N=4. A third time period X3 corresponds to N=2.

Among other examples, the techniques of the disclosure describe determination of the time period X and one or more RO groups within the time period X, in accordance with agreements reached with respect to PRACH repetition in a work item of the 3rd Generation Partnership Project (3GPP) new Release 18 entitled “Further NR Coverage Enhancement”. The use of RO groups provides advantages in optimizing resource allocation for random access processes, reducing signaling overhead, and improving the efficiency of random access in the network. Instead of individually assigning ROs to each user device (UE) for random access, the base station can group multiple ROs together and allocate them to a specific set of UEs. This efficient resource allocation helps prevent resource wastage and ensures that available resources are utilized efficiently. Moreover, the base station can inform UEs about the available resource opportunities for random access using a single control message. Transmitting information about RO groups instead of individual ROs reduces the signaling overhead, which is beneficial when there are many UEs in the cell or when random access activity is high.

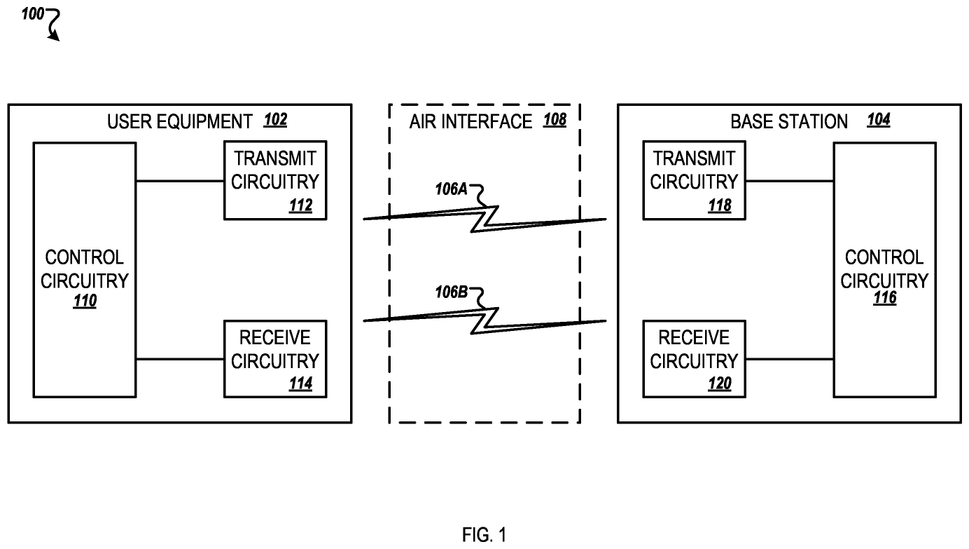

FIG. 1 illustrates an example wireless network, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or an NR-EUTRA Dual Connectivity (NE-DC) network. However, the wireless network 100 may also be a Standalone SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, base station 104 provides the UE 102 network connectivity to a broader network (not shown). This UE 102 connectivity is provided via the air interface 108 in a base station service area provided by base station 104. In some implementations, such a broader network may be a wide area network operated by a cellular network provider, or may be the Internet. Each base station service area associated with base station 104 is supported by antennas integrated with base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “EUTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, an NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a +sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

In some implementations, multiple Physical Random Access Channel (PRACH) transmissions for PRACH repetition with the same transmitting beam use one RACH Occasion (RO) group. In some implementations, one or more RO groups are used for multiple PRACH transmissions, each RO group having a different preamble on shared ROs. In some implementations, one or more RO groups are used for multiple PRACH transmissions on separate ROs. Each RO group includes valid ROs (ROs that are defined in an existing specification) used for a particular number of multiple PRACH transmissions (a particular PRACH repetition number). All ROs in one RO group is associated with the same Synchronization Signal Block (SSB).

Multiple PRACH transmissions (PRACH repetition) within one Random Access Channel (RACH) attempt are performed within one RO group. The number of valid ROs in the RO group is equal to the number of multiple PRACH transmissions (a PRACH repetition number). The PRACH repetition number is configured by the network. For example, the PRACH repetition number can be configured as 2, 4, or 8. If the PRACH repetition number is configured as 2, there are 2 ROs in each RO group. If the PRACH repetition number is configured as 4, there are 4 ROs in each RO group. If the PRACH repetition number is configured as 8, there are 8 ROs in each RO group. One or more RO groups corresponding to a configured PRACH repetition number are determined/configured within a time period X, starting from radio frame 0. The determined/configured one or more RO groups repeat every time period X. The time period X includes K SSB-to-RO association pattern periods. SSB-to-RO group mapping is the same in each SSB-to-RO association pattern period (also referred to as “association pattern period”).

In some implementations, the number of association pattern periods K within the time period X is configured by the network. In some implementations, K is determined or calculated based on a particular rule. In some implementations, K is a fixed value.

In some implementations, an index of a starting RO in each RO group is configured by the network. In some implementations, a time domain starting position and a frequency domain starting position of the first valid RO in each RO group are determined based on a particular rule.

In some implementations, a single time period X is applied to all the PRACH repetition numbers or levels (e.g., 2, 4, or 8), e.g., in a shared RO scenario. In some implementations, different values of time period X are applied to different PRACH repetition numbers in shared RO or separate RO scenarios, or both. For example, in some cases, a first time period X1 is applied to one or more RO groups when the PRACH repetition number is 8. A second time period X2 is applied to one or more RO groups when the PRACH repetition number is 4. A third time period X3 is applied to one or more RO groups when the PRACH repetition number is 2.

### Determination of the Time Period X

In some implementations, the time period X can be implicitly determined based on the number of ROs M associated with the particular SSB in a single SSB-to-RO association pattern period P and a particular PRACH repetition number N. In some implementations, the number of association pattern periods K within the time period X (X=K×P) is explicitly configured by the base station.

### Implicit Determination of Time Period X

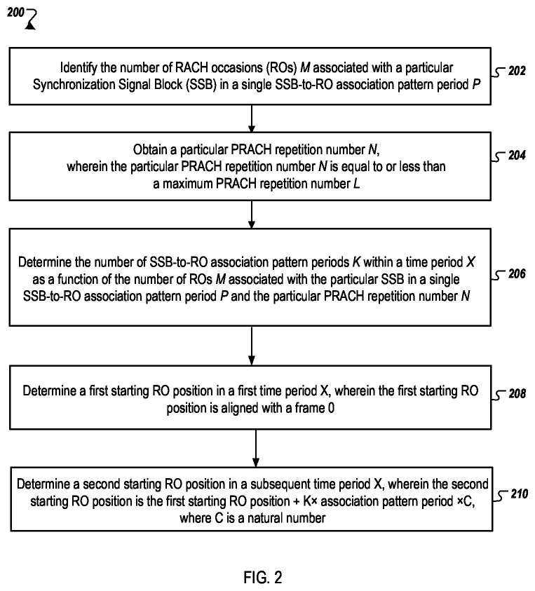

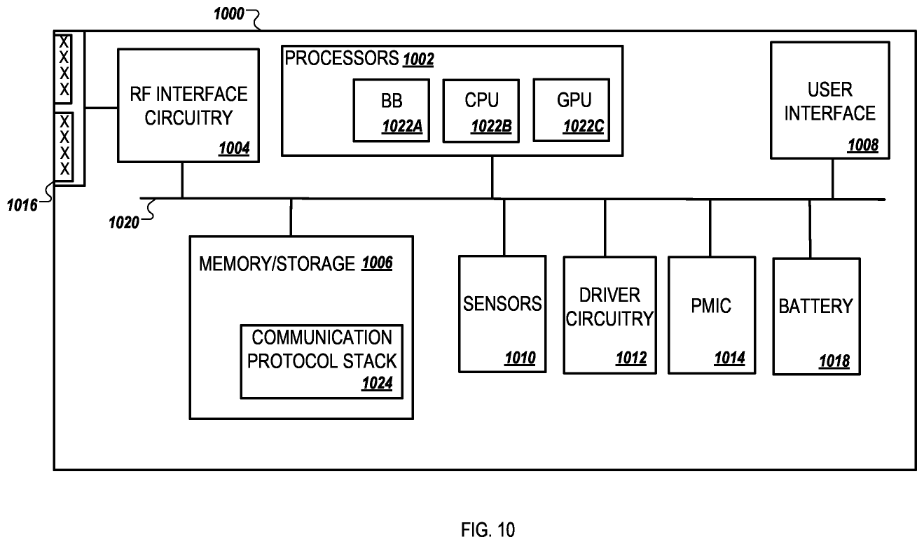

FIG. 2 illustrates an example process of determining a time period X and one or more RO groups within the time period X, according to some implementations. The process 200 is described as being performed by UE such as UE 102 of FIG. 1 or UE 1000 of FIG. 10, in some implementations.

At 202, the UE identifies the number of PRACH occasions or RACH occasions (ROs) M associated with a particular Synchronization Signal Block (SSB) in a single SSB-to-RO association pattern period P. As defined in TS 38.213 section 8.1, an association pattern period P includes one or more association periods and is determined so that a pattern between PRACH occasions and Synchronization Signal/Physical Broadcast Channel (SS/PBCH) block indexes repeats at most every 160 milliseconds. An association period, starting from radio frame 0, for mapping SS/PBCH block indexes to PRACH occasions is the smallest value in the set determined by the PRACH configuration period. SS/PBCH block indexes are mapped at least once to the PRACH occasions within the association period. In some implementations, an association pattern period P can be e.g., 10 milliseconds, 20 milliseconds, 40 milliseconds, 80 milliseconds, or 160 milliseconds.

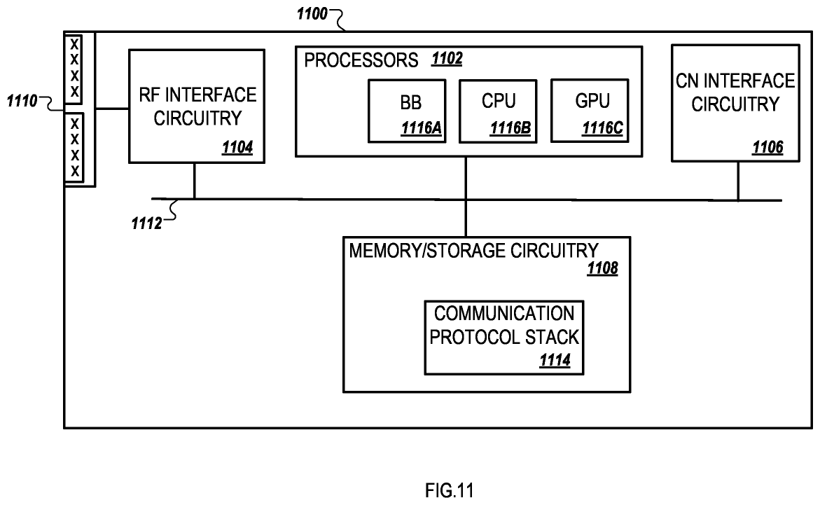

At 204, the UE obtains a particular PRACH repetition number N. The particular PRACH repetition number N is equal to or less than a maximum PRACH repetition number L. The number of ROs in a RO group is the same as the particular PRACH repetition number N. For example, if the base station (e.g., base station 104 of FIG. 1 or base station 1100 of FIG. 11) configures a PRACH repetition number N as one of {8, 4, 2}, the maximum PRACH repetition number L is 8. For another example, if the base station configures a PRACH repetition number N as one of {4, 2}, the maximum PRACH repetition number L is 4.

At 206, the UE determines the number of SSB-to-RO association pattern periods K within a time period X as a function of the number of ROs M associated with the particular SSB in a single SSB-to-RO association pattern period P and the particular PRACH repetition number N. K is determined using Equation (1), and X is determined using Equation (2).

$$K = \{ \begin{matrix}⌈ \frac{N}{M} ⌉ & if N \geq M \\ 1 & if N < M\end{matrix} \qquad ( 1 )$$

$$X = K \times P \qquad ( 2 )$$

Where M is the number of ROs associated with the same SSB in a single association pattern period P, and N is the configured PRACH repetition number, e.g., 8, 4, or 2. The function ┌x┐ is a ceiling function that rounds a given number x to the smallest integer greater than or equal to x.

In some implementations, if there is only one association pattern period P within the time period X, i.e., K=1, the number of RO groups within the time period X is

$$⌈ \frac{M}{N} ⌉ .$$

In some implementations, the base station can configure whether all the RO groups within the time period X are used for PRACH repetition, or only some of the RO groups within the time period X are used for PRACH repetition. In some implementations, the ROs not included in any RO groups within the time period X are not used for PRACH repetition.

### One Time Period X Corresponding to All PRACH Repetition Levels

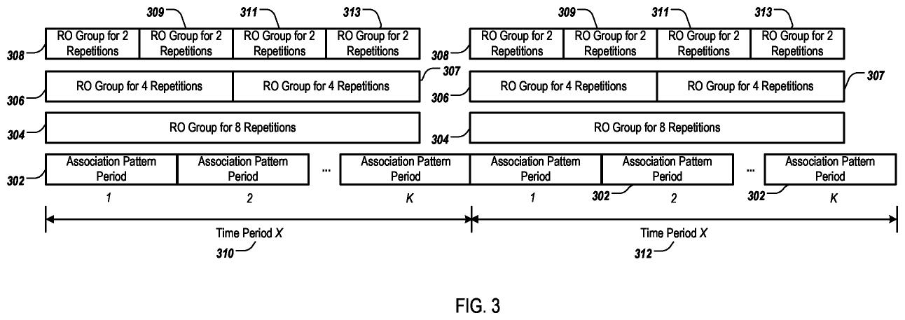

In some implementations, only one time period X is applied to all PRACH repetition levels or numbers (e.g., 8, 4, 2), in a shared RO scenario. FIG. 3 illustrates a single time period X applied to all PRACH repetition levels, according to some implementations. All the PRACH repetition levels have the same number of association pattern periods K (K is the same for all the PRACH repetition levels, e.g., 8, 4, 2). As shown in FIG. 3, one time period X includes K association pattern periods 302. The determined/configured one or more RO groups repeat every time period X. The configured PRACH repetition number N is equal to the maximum PRACH repetition number L, e.g., 8, when calculating K using Equation (1). The value of K calculated based on N=L applies to all PRACH repetition levels.

If the configured PRACH repetition number N is equal to the maximum PRACH repetition number L (e.g., 8), the UE obtains a single RO group 304 within the time period X. The number of ROs in the single RO group is the maximum PRACH repetition number L (e.g., 8).

If the configured PRACH repetition number N is ½×the maximum PRACH repetition number L (e.g., 4), the UE obtains two RO groups 306, 307 within the time period X. The number of ROs in each RO group is ½×L (e.g., 4).

If the configured PRACH repetition number N is ¼×the maximum PRACH repetition number L (e.g., 2), the UE obtains four RO groups 308, 309, 311, 313 within the time period X. The number of ROs in each RO group is ¼×L (e.g., 2).

In some implementations, when the single SSB-to-RO association pattern period 302 includes at least L ROs (e.g., 8 ROs), K=1. There is only one SSB-to-RO association pattern period 302 within the time period X.

In an example, if the configured PRACH repetition number N is configured as 8 and there a 3 ROs associated with the same SSB in a single association pattern period

$$K = ⌈ \frac{8}{3} ⌉ = 3$$

is the minimal number of association pattern periods to provide 8 ROs. Each association pattern period includes 3 ROs, and thus 3 association pattern periods include 9 ROs. The first 8 ROs are used for PRACH repetition, while the last RO in the third association pattern period is not used for PRACH repetition. If the PRACH repetition number N is configured as 2, 8 ROs are divided into 4 RO groups 308, 309, 311, 313. If the PRACH repetition number N is configured as 4, 8 ROs are divided into 2 RO groups 306, 307.

### Determination of Time Domain Starting Position

In some implementations, the UE further determines a time domain starting position of each RO group within the time period X. As shown in FIGS. 2 and 3, at 208, the UE determines a first starting RO position in a first time period 310. Regardless of the value of the PRACH repetition number N, the first starting RO position in a first time period 310 is aligned with a radio frame 0 (System Frame Number is zero).

At 210, the UE determines a starting RO position in a subsequent time period 312. If the PRACH repetition number N is equal to the maximum PRACH repetition number L (e.g., 8), the starting RO position in the subsequent time period 312 is the first starting RO position+K×association pattern period×C, where C is a natural number. The starting RO of each subsequent time period 312 is determined as a multiple of K association pattern periods. Each time period 310, 312 includes one RO group 304.

If the configured PRACH repetition number N is ½×the maximum PRACH repetition number L (e.g., 4), the UE provides two RO groups 306, 307 within each time period 310, 312. The number of ROs in each RO group 306, 307 is ½×L (e.g., 4). The UE determines starting RO position in a second RO group 307 in the first time period 310. The starting RO position in the second RO group 307 is the first starting RO position+½×L×RO. The duration of each RO is configured by the base station, and can be several Orthogonal Frequency Division Multiplexing (OFDM) symbols and up to 3 millisecond.

If the configured PRACH repetition number N is ¼×the maximum PRACH repetition number L (e.g., 2), the UE provides four RO groups 308, 309, 311, 313 within each time period 310, 312. The number of ROs in each RO group 308, 309, 311, 313 is ¼×L (e.g., 4). The UE determines a starting RO position in a subsequent RO group 309, 311, 313 (the second RO group 309, the third RO group 311, and the fourth RO group 313) in the first time period 310. The starting RO position is the first starting RO position+¼×L×RO×m, where m=1, 2, or 3. If m=1, the starting RO position corresponds to the second RO group 309 in the first time period 310. If m=2, the starting RO position corresponds to the third RO group 311 in the first time period 310. If m=3, the starting RO position corresponds to the fourth RO group 313 in the first time period 310. The duration of each RO is configured by the base station, and can be several Orthogonal Frequency Division Multiplexing (OFDM) symbols and up to 3 milliseconds.

### Determination of Frequency Domain Starting Position

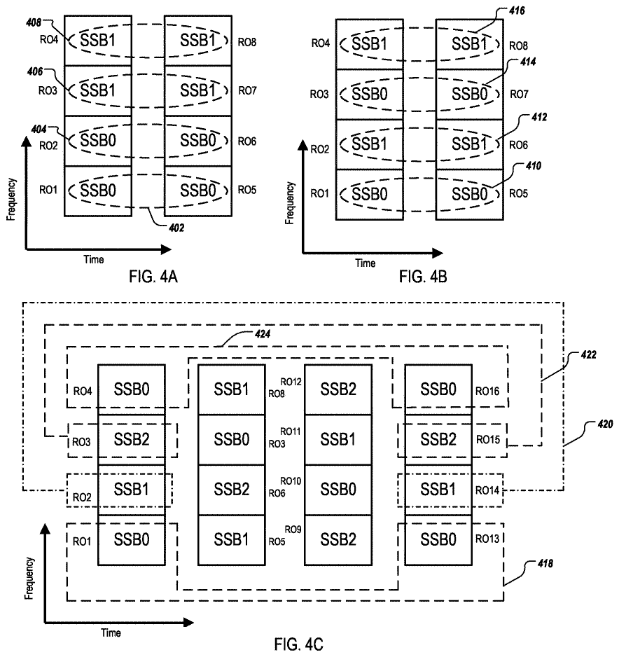

In some implementations, ROs associated with the particular SSB in each RO group have the same frequency position, according to some implementations. FIGS. 4A-4C illustrate a frequency position of ROs associated with the same SSB in each RO group. As shown in FIGS. 4A-4C, each RO group includes 2 ROs (the configured PRACH repetition number N is 2). As shown in FIG. 4A, RO group 402 includes RO1 and RO5. RO group 404 includes RO2 and RO6. RO group 406 includes RO3 and RO7. RO group 408 includes RO4 and RO8. RO groups 402 and 404 are associated with SSB0, while RO groups 406 and 408 are associated with SSB1. RO1 and RO5 in RO group 402 have the same frequency position. RO2 and RO6 in RO group 404 have the same frequency position. RO3 and RO7 in RO group 406 have the same frequency position. RO4 and RO8 in RO group 408 have the same frequency position.

As shown in FIG. 4B, RO group 410 includes RO1 and RO5. RO group 412 includes RO2 and RO6. RO group 414 includes RO3 and RO7. RO group 416 includes RO4 and RO8. RO groups 410 and 414 are associated with SSB0, while RO groups 412 and 416 are associated with SSB1. RO1 and RO5 in RO group 410 have the same frequency position. RO2 and RO6 in RO group 412 have the same frequency position. RO3 and RO7 in RO group 414 have the same frequency position. RO4 and RO8 in RO group 416 have the same frequency position.

As shown in FIG. 4C, RO group 418 includes RO1 and RO13. RO group 420 includes RO2 and RO14. RO group 422 includes RO3 and RO15. RO group 424 includes RO4 and RO16. RO groups 418 and 424 are associated with SSB0. RO group 420 is associated with SSB1. RO group 422 is associated with SSB2. RO1 and RO13 in RO group 418 have the same frequency position. RO2 and RO14 in RO group 420 have the same frequency position. RO3 and RO15 in RO group 422 have the same frequency position. RO4 and RO16 in RO group 424 have the same frequency position.

In some implementations, if frequency division multiplexing (FDM) is configured for ROs and frequency hopping is enabled for PRACH repetition, the UE performs frequency hopping within ROs configured with FDM. In some implementations, the base station configures a frequency offset for frequency hopping. In some implementations, the UE performs frequency hopping from one predefined frequency position to another predefined frequency position.

In some implementations, an RO with a larger index is dropped or discarded for PRACH repetition, so that the number of ROs configured with FDM associated with the same SSB can be the same at different time instances. For example, if there are two ROs at a first time instance and one RO at a second time instance, the RO with a larger index at the first time instance is dropped or discarded, so that there is one RO at the first time instance and at the second time instance.

### One Time Period X Corresponding to One PRACH Repetition Level

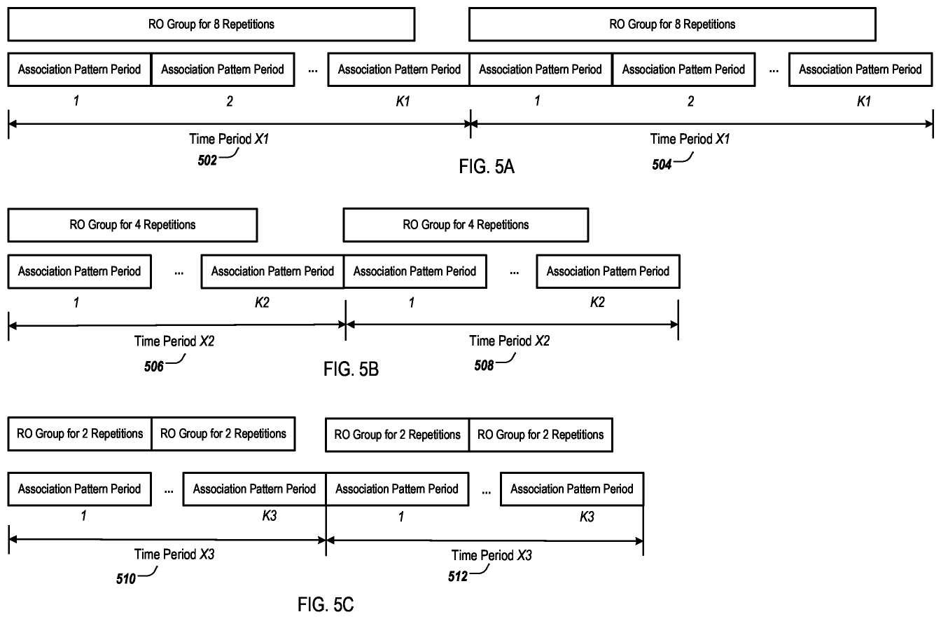

In some implementations, each PRACH repetition level corresponds to its own K. FIGS. 5A-5C illustrate a different repetition level corresponding to a different time period, according to some implementations. As shown in FIGS. 5A-5C, K1 (the configured PRACH repetition number N is 8), K2 (the configured PRACH repetition number N is 4), and K3 (the configured PRACH repetition number N is 2) are different, and thus the time period X1, the time period X2, and the time period X3 are also different.

In some implementations, the time domain starting position of RO groups for each PRACH repetition level is determined based on its own value K (K1, K2, K3). The first starting RO positions in the first time period 502, 506, 510, respectively are starting with radio frame 0. The starting RO positions in the subsequent time periods 504, 508, 512, respectively, are relative to the first starting RO positions in the first time period 502, 506, 510, respectively.

The starting RO position in a subsequent time period is the first starting RO position +K×association pattern period×C, where C is a natural number. If the PRACH repetition number N is equal to the maximum PRACH repetition number L (e.g., 8), the starting RO position in a subsequent time period 504 is the first starting RO position+K1×association pattern period×C. If the PRACH repetition number N is ½×the maximum PRACH repetition number L (e.g., 4), the starting RO position in a subsequent time period 508 is the first starting RO position+K2×association pattern period×C. If the PRACH repetition number N is ¼×the maximum PRACH repetition number L (e.g., 2), the starting RO position in a subsequent time period 512 is the first starting RO position+K3×association pattern period×C.

In some implementations, ROs associated with the particular SSB in each RO group have the same frequency position.

In some implementations, if frequency division multiplexing (FDM) is configured for ROs and frequency hopping is enabled for PRACH repetition, the UE performs frequency hopping within ROs configured with FDM. In some implementations, the base station configures a frequency offset for frequency hopping. In some implementations, the UE performs frequency hopping from one predefined frequency position to another predefined frequency position. In some implementations, an RO with a larger index is dropped or discarded for PRACH repetition, so that the number of ROs configured with FDM associated with the same SSB can be the same at different time instances.

### Explicit Determination of Time Period X

In some implementations, the base station configures K through Radio Resource Control (RRC) signaling or System Information Block 1 (SIB1). The time period X including K association pattern period P is accordingly determined using X=K×P.

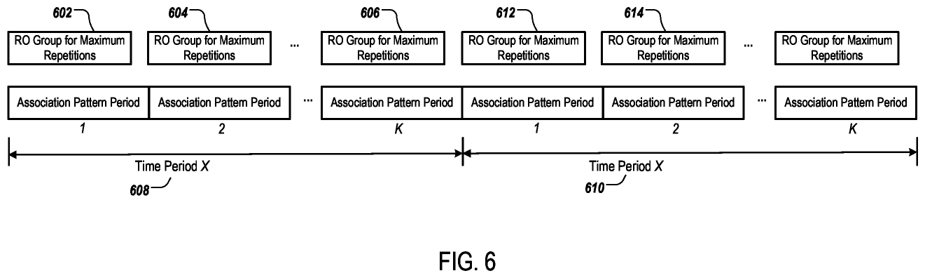

In some implementations, unlike having a single RO group within the time period X (referring to RO group 304 of FIG. 3 under “Implicit Determination of Time Period X”), there are multiple RO groups within the time period X if the PRACH repetition number N is equal to the maximum PRACH repetition number L (e.g., 8). FIG. 6 illustrates multiple RO groups 602, 604, 606, etc., within a time period X for a maximum repetition level, according to some implementations.

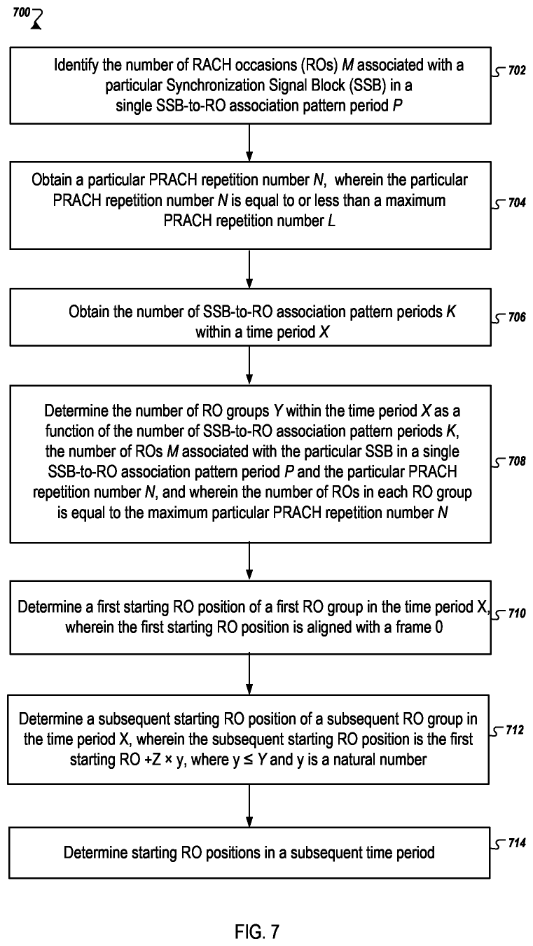

FIG. 7 illustrates an example process of determining a time period X and multiple RO groups within the time period X, according to some implementations. The process 700 is described as being performed by UE such as UE 102 of FIG. 1 or UE 1000 of FIG. 10, in some implementations.

At 702, similar to 202 of FIG. 2, the UE identifies the number of ROs M associated with a particular Synchronization Signal Block (SSB) in a single SSB-to-RO association pattern period P.

At 704, similar to 204 of FIG. 2, the UE obtains a particular PRACH repetition number N. The particular PRACH repetition number N is equal to or less than a maximum PRACH repetition number L.

At 706, the UE obtains the number of SSB-to-RO association pattern periods K within a time period X. The base station (e.g., base station 104 of FIG. 1 or base station 1100 of FIG. 11) configures K, and K can be a natural number.

At 708, the UE determines the number of RO groups Y within the time period X as a function of the number of SSB-to-RO association pattern periods K, the number of ROs M associated with the particular SSB in a single SSB-to-RO association pattern period P, and the particular PRACH repetition number N. The number of ROs in each RO group is equal to the particular PRACH repetition number N, e.g., 8, 4, or 2.

In some implementations, the number of RO groups Y within a single time period X is determined using Equations (3) and (4).

$$Z = \{ \begin{matrix}⌈ \frac{N}{M} ⌉ & if N \geq M \\ ⌈ \frac{M}{N} ⌉ & if N < M\end{matrix} \qquad ( 3 )$$

$$Y = \{ \begin{matrix}⌈ K / Z ⌉ & if N \geq M \\ K * Z & if N < M\end{matrix} \qquad ( 4 )$$

Where M is the number of ROs associated with the same SSB in an association pattern period, N is the particular PRACH repetition number. If N is larger than or equal to M, Z is the number of association pattern periods for a RO group. If N is smaller than M, Z is the number of RO groups in one association pattern period. The number of RO groups Y within a single time period X is then determined based on Z.

In some implementations, the number of RO groups Y within a single time period X is determined using Equations (5):

$$Y = ⌈ K * \frac{M}{N} ⌉ .$$

The second RO group follows the end of the first RO group.

### One Time Period X Corresponding to All PRACH Repetition Levels

In some implementations, similar to FIG. 3, the base station configures K, which is applied to all PRACH repetition levels or numbers, i.e., only one time period X is applied to all PRACH repetition levels or numbers (e.g., 8, 4, 2), in a shared RO scenario. The configured PRACH repetition number N is equal to the maximum PRACH repetition number L, e.g., 8, when calculating Y using Equations (3) and (4) or using Equation (5). Y is calculated based on N=L (e.g., 8). For example,

$$Z = \{ \begin{matrix}⌈ \frac{8}{M} ⌉ & if 8 \geq M \\ ⌈ \frac{M}{8} ⌉ & if 8 < M\end{matrix} , and Y = \{ \begin{matrix}⌈ K / Z ⌉ & if 8 \geq M \\ K * Z & if 8 < M\end{matrix} .$$

If the configured PRACH repetition number N is ½×the maximum PRACH repetition number L (e.g., 4), the UE determines that there are 2×Y RO groups within the time period X. The number of ROs in each RO group is ½×L (e.g., 4).

If the configured PRACH repetition number N is ¼×the maximum PRACH repetition number L (e.g., 2), the UE determines that there are 4×Y RO groups within the time period X. The number of ROs in each RO group is ¼×L (e.g., 2).

### One Time Period X Corresponding to One PRACH Repetition Level

In some implementations, similar to FIGS. 5A-5C, each PRACH repetition level corresponds to its own configured K (K1, K2, K3), and thus each PRACH repetition level corresponds to its own Y, when calculating Y using Equations (3) and (4) or using Equation (5).

For example, when

$$N = 8 , Z = \{ \begin{matrix}⌈ \frac{8}{M} ⌉ & if 8 \geq M \\ ⌈ \frac{M}{8} ⌉ & if 8 < M\end{matrix} , Y = \{ \begin{matrix}⌈ K 1 / Z ⌉ & if 8 \geq M \\ K 1 * Z & if 8 < M\end{matrix} .$$

### When

$$N = 4 , Z = \{ \begin{matrix}⌈ \frac{4}{M} ⌉ & if 4 \geq M \\ ⌈ \frac{M}{4} ⌉ & if 4 < M\end{matrix} , \\ Y = \{ \begin{matrix}⌈ K 2 / Z ⌉ & if 4 \geq M \\ K 2 * Z & if 4 < M\end{matrix} . When N = 2 , Z = \{ \begin{matrix}⌈ \frac{2}{M} ⌉ & if 2 \geq M \\ ⌈ \frac{M}{2} ⌉ & if 2 < M\end{matrix} ,$$

$$Y = \{ \begin{matrix}⌈ K 3 / Z ⌉ & if 2 \geq M \\ K 3 * Z & if 2 < M\end{matrix} .$$

### Determination of Time Domain Starting Position

In some implementations, the UE further determines a time domain starting position of each RO group within the time period X. As shown in FIGS. 6 and 7, at 710, the UE determines a first starting RO position of a first RO group 602 in a first time period 608. Regardless of the value of the PRACH repetition number N, the first starting RO position in a first time period 310 is aligned with a radio frame 0.

At 712, the UE determines a subsequent starting RO position of a subsequent RO group 604 in the first time period 608. The subsequent starting RO position is the first starting RO+Z×y, where y≤Y and y is a natural number, and

$$Z = \{ \begin{matrix}⌈ \frac{N}{M} ⌉ & if N \geq M \\ ⌈ \frac{M}{N} ⌉ & if N < M\end{matrix} .$$

At 714, the UE determines starting RO positions in a subsequent time period 610 as the first starting RO+Z×(y−1)+K×association pattern period×C, where y≤Y, y is a natural number, and C is a natural number. For example, the starting RO position of the RO group 612 is the first starting RO position+K×association pattern period×C, where C is a natural number (y=1 and C=1 for RO group 612). The starting RO position of the RO group 614 is the subsequent starting RO position+K×association pattern period×C, where C is a natural number (y=2 and C=1 for RO group 614).

### Determination of Frequency Domain Starting Position

In some implementations, similar to FIGS. 4A-4C, ROs associated with the particular SSB in each RO group have the same frequency position.

In some implementations, if frequency division multiplexing (FDM) is configured for ROs and frequency hopping is enabled for PRACH repetition, the UE performs frequency hopping within ROs configured with FDM. In some implementations, the base station configures a frequency offset for frequency hopping. In some implementations, the UE performs frequency hopping from one predefined frequency position to another predefined frequency position.

In some implementations, an RO with a larger index is dropped or discarded for PRACH repetition, so that the number of ROs configured with FDM associated with the same SSB can be the same at different time instances. For example, if there are two ROs at a first time instance and one RO at a second time instance, the RO with a larger index at the first time instance is dropped or discarded, so that there is one RO at the first time instance and at the second time instance.

### RO Group Density Control

In some implementations, the base station controls RO group density within the time period X. In some examples, the UE selects only a first RO group within the time period X used for multiple repetitions of the PRACH transmission. The density is controlled based on the configured parameter K. In some examples, the UE provides a bitmap indicating one or more RO groups within the time period X used for multiple repetitions of the PRACH transmission. The bitmap indicates which RO groups in the time period X are used for PRACH repetition based on Y determined using Equations (3) and (4) or using Equation (5). In some examples, the base station configures a RO group ratio within the time period X to be used for PRACH repetition. For example, if the RO group ratio is configured to be 50%, then the first 50% RO groups are valid RO groups used for PRACH repetition. In some examples, the base station configures one or more odd RO groups or one or more even RO groups within the time period X used for multiple repetitions. For example, the odd RO groups in the time period X are used for PRACH repetition, while the even RO groups are not used for PRACH repetition, or vice versa.

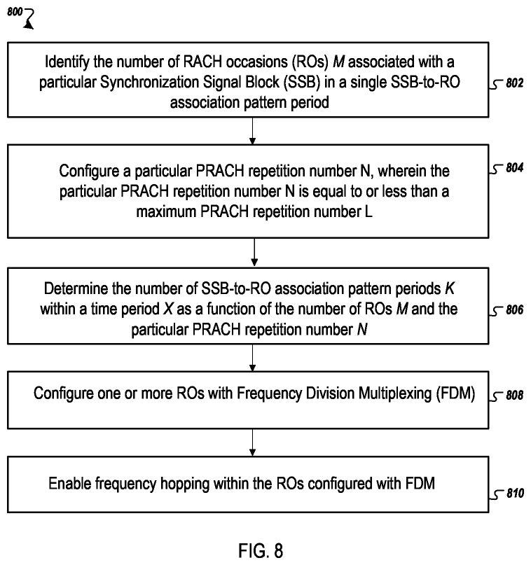

FIG. 8 illustrates another example process of determining a time period X and one or more RO groups within the time period X, according to some implementations. The process 800 is described as being performed by base station 104 of FIG. 1 or base station 1100 of FIG. 11, in some implementations.

At 802, the base station identifies the number of RACH occasions (ROs) M associated with a particular Synchronization Signal Block (SSB) in a single SSB-to-RO association pattern period P.

At 804, the base station configures a particular PRACH repetition number N. The particular PRACH repetition number N is equal to or less than a maximum PRACH repetition number L. The number of ROs in a RO group is the same as the particular PRACH repetition number N.

At 806, the base station determines the number of SSB-to-RO association pattern periods K within a time period X as a function of the number of ROs M associated with the particular SSB in a single SSB-to-RO association pattern period P and the particular PRACH repetition number N. K is determined using Equation (1), and X is determined using Equation (2).

At 808, the base station configures one or more ROs with Frequency Division Multiplexing (FDM). The configured one or more ROs can be used for FDM.

At 810, the base station enables frequency hopping within the one or more ROs configured with FDM. The frequency hopping occurs within the configured one or more ROs used for FDM.

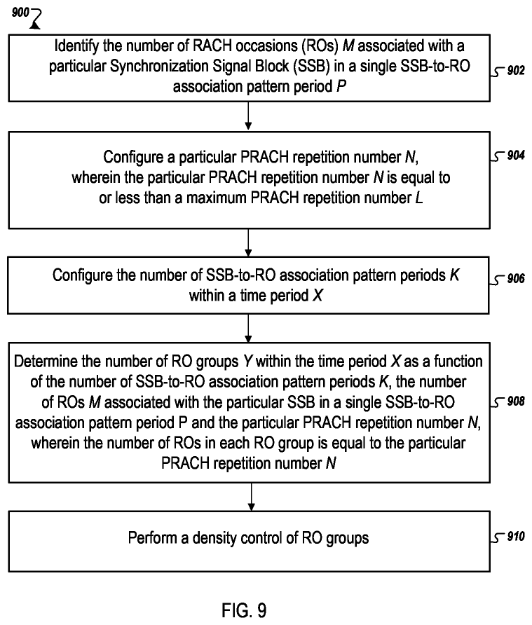

FIG. 9 illustrates another example process of determining a time period X and multiple RO groups within the time period X, according to some implementations. The process 900 is described as being performed by base station 104 of FIG. 1 or base station 1100 of FIG. 11, in some implementations.

At 902, similar to 802 of FIG. 8, the base station identifies the number of ROs M associated with a particular Synchronization Signal Block (SSB) in a single SSB-to-RO association pattern period P.

At 904, similar to 804 of FIG. 8, the base station configures a particular PRACH repetition number N. The particular PRACH repetition number N is equal to or less than a maximum PRACH repetition number L.

At 906, the base station configures the number of SSB-to-RO association pattern periods K within a time period X.

At 908, the base station determines the number of RO groups Y within the time period X as a function of the number of SSB-to-RO association pattern periods K, the number of ROs M associated with the particular SSB in a single SSB-to-RO association pattern period P and the particular PRACH repetition number N. The number of ROs in each RO group is equal to the particular PRACH repetition number N, e.g., 8, 4, or 2.

In some implementations, the number of RO groups Y within a single time period X is determined using Equations (3) and (4). In some implementations, the number of RO groups Y within a single time period X is determined using Equations (5). The second RO group follows the end of the first RO group.

At 910, the base station performs a density control of RO groups. In some examples, the base station selects only a first RO group within the time period X used for multiple repetitions of the PRACH transmission. The density is controlled based on the configured parameter K. In some examples, the base station provides a bitmap indicating one or more RO groups within the time period X used for multiple repetitions of the PRACH transmission. The bitmap indicates which RO groups in the time period X are used for PRACH repetition based on Y determined using Equations (3) and (4) or using Equation (5). In some examples, the base station configures a RO group ratio within the time period X to be used for PRACH repetition. In some examples, the base station configures one or more odd RO groups or one or more even RO groups within the time period X used for multiple repetitions.

FIG. 10 is a block diagram of an example UE, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smartwatch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 includes any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016.

In various implementations, the RF interface circuitry 1004 may be configured to transmit/receive signals in a manner compatible with NR access technologies.

The antenna 1016 may include antenna elements to convert electrical signals into radio waves to travel through the air and convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FRI or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensor circuitry 1010 and control and allow access to sensor circuitry 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000 including DRX as discussed herein. A battery 1018 may power the UE 1000, although in some examples the UE 1000 may be mounted or deployed in a fixed location, and may have a power supply coupled to an electrical grid. The battery 1018 may be a lithium-ion battery, a metal-air battery, such as a zinc-air battery, an aluminum-air battery, a lithium-air battery, and the like. In some implementations, such as in vehicle-based applications, the battery 1018 may be a typical lead-acid automotive battery.

FIG. 11 is a block diagram of an example access node, according to some implementations. FIG. 11 illustrates an access node 1100 (e.g., a base station or gNB), in accordance with some implementations. The access node 1100 may be similar to and substantially interchangeable with the base station 104 of FIG. 1. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells, or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1100; a MAC/PHY split wherein RRC, PDCP, RLC, and MAC layers are operated by the CRAN/vBBUP and the PHY layer is operated by the access node 1100; or a “lower PHY” split wherein RRC, PDCP, RLC, MAC layers and upper portions of the PHY layer are operated by the CRAN/vBBUP and lower portions of the PHY layer are operated by the access node 1100.

In V2X scenarios, the access node 1100 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

### Examples

In the following section, further exemplary embodiments are provided.

Example 1 includes one or more processors of a user equipment (UE), the one or more processors configured to perform operations for multiple Physical Random Access Channel (PRACH) transmissions, the operations including: identifying the number of RACH occasions (ROs) M associated with a particular Synchronization Signal Block (SSB) in a single SSB-to-RO association pattern period P; obtaining a particular PRACH repetition number N, wherein the particular PRACH repetition number N is equal to or less than a maximum PRACH repetition number L; and determining the number of SSB-to-RO association pattern periods K within a time period X as a function of the number of ROs M associated with the particular SSB in a single SSB-to-RO association pattern period P and the particular PRACH repetition number N.

Example 2 is the one or more processors of Example 1, wherein

$$K = \{ \begin{matrix}⌈ \frac{N}{M} ⌉ & if N \geq M \\ 1 & if N < M\end{matrix} and X = K \times P .$$

Example 3 is the one or more processors of Example 1, the operations further including: obtaining one or more RO groups within the time period X, wherein at least one RO group is associated with the particular PRACH repetition number N, wherein the number of ROs in the at least one RO group is the same as the particular PRACH repetition number N.

Example 4 is the one or more processors of Example 1, wherein the particular PRACH repetition number N is the maximum PRACH repetition number L, the operations further including: obtaining a single RO group within the time period X, wherein the number of ROs in the single RO group is the maximum PRACH repetition number L.

Example 5 is the one or more processors of Example 1, wherein the particular PRACH repetition number N is ½×the maximum PRACH repetition number L, the operations further including: obtaining two RO groups within the time period X, wherein the number of ROs in each RO group is ½×L.

Example 6 is the one or more processors of Example 1, wherein the particular PRACH repetition number N is ¼×the maximum PRACH repetition number L, the operations further including: obtaining four RO groups within the time period X, wherein the number of ROs in each RO group is ¼×L.

Example 7 is the one or more processors of Example 3, wherein when the single SSB-to-RO association pattern period P includes at least L ROs, K=1.

Example 8 is the one or more processors of Example 7, when K=1, the number of RO groups within the time period X is

$$⌈ \frac{M}{N} ⌉ .$$

Example 9 is the one or more processors of Example 3, the operations further including: determining a first starting RO position in a first time period X, wherein the first starting RO position is aligned with a radio frame 0; and determining a second starting RO position in a subsequent time period X, wherein the second starting RO position is the first starting RO position +K×association pattern period×C, where C is a natural number.

Example 10 is the one or more processors of Example 9, wherein the particular PRACH repetition number N is ½×the maximum PRACH repetition number L, the operations further including: providing two RO groups within the time period X, wherein the number of ROs in each RO group is ½×L; and determining a third starting RO position in a second RO group in the first time period X, wherein the third starting RO position is the first starting RO position+½×L×RO.

Example 11 is the one or more processors of Example 9, wherein the particular PRACH repetition number N is ¼×the maximum PRACH repetition number L, the operations further including: providing four RO groups within the time period X, wherein the number of ROs in each RO group is ¼×L; and determining a third starting RO position in a subsequent RO group in the first time period X, wherein the third starting RO position is the first starting RO position+¼×L×RO×m, where m=1, 2, or 3.

Example 12 is the one or more processors of Example 3, wherein the number of SSB-to-RO association pattern periods K is the same for any particular PRACH repetition number.

Example 13 is the one or more processors of Example 3, wherein the number of SSB-to-RO association pattern periods K is associated with the particular PRACH repetition number N, wherein a different N corresponds to a different K.

Example 14 is the one or more processors of Example 3, wherein ROs associated with the particular SSB in each RO group have the same frequency position.

Example 15 is the one or more processors of Example 3, the operations further including: obtaining one or more ROs configured with Frequency Division Multiplexing (FDM); and enabling frequency hopping within the ROs configured with FDM.

Example 16 is the one or more processors of Example 15, wherein the number of ROs configured with FDM and associated with the particular SSB is the same at different time instances.

Example 17 is the one or more processors of Example 16, the operations further including: dropping a RO having a larger index at a particular time instance, so that the number of ROs configured with FDM and associated with the particular SSB is the same.

Example 18 may include a method of performing operations of any one of Examples 1-17.

Example 19 may include a user equipment (UE), including: one or more processors; and one or more memory devices storing instructions that, when executed, cause the one or more processors to perform operations of any one of Examples 1-17.

Example 20 includes one or more processors of a user equipment (UE), the one or more processors configured to perform operations for multiple Physical Random Access Channel (PRACH) transmissions, the operations including: identifying the number of RACH occasions (ROs) M associated with a particular Synchronization Signal Block (SSB) in a single SSB-to-RO association pattern period P; obtaining a particular PRACH repetition number N, wherein the particular PRACH repetition number N is equal to or less than a maximum PRACH repetition number L; obtaining the number of SSB-to-RO association pattern periods K within a time period X; and determining the number of RO groups Y within the time period X as a function of the number of SSB-to-RO association pattern periods K, the number of ROs M associated with the particular SSB in a single SSB-to-RO association pattern period P and the particular PRACH repetition number N, wherein the number of ROs in each RO group is equal to the particular PRACH repetition number N.

Example 21 is the one or more processors of Example 20, wherein

$$Y = \{ \begin{matrix}⌈ K / ⌈ \frac{N}{M} ⌉ ⌉ & if N \geq M \\ K * ⌈ \frac{M}{N} ⌉ & if N < M\end{matrix} and X = K \times P .$$

Example 22 is the one or more processors of Example 20, wherein the number of SSB-to-RO association pattern periods K is obtained through Radio Resource Control (RRC) signaling or System Information Block 1 (SIB1).

Example 23 is the one or more processors of Example 20, wherein the particular PRACH repetition number N is ½×the maximum PRACH repetition number L, the operations further including: determining the number of RO groups 2×Y within the time period X, wherein the number of ROs in each RO group is ½×L.

Example 24 is the one or more processors of Example 20, wherein the particular PRACH repetition number N is ¼×the maximum PRACH repetition number L, the operations further including: determining the number of RO groups 4×Y within the time period X, wherein the number of ROs in each RO group is ¼×L.

Example 25 is the one or more processors of Example 20, the operations further including: determining a first starting RO position of a first RO group in the time period X, wherein the first starting RO position is aligned with a radio frame 0; and determining a subsequent starting RO position of a subsequent RO group in the time period X, wherein the subsequent starting RO position is the first staring RO +Z×y, where y≤Y and y is a natural number, and

$$Z = \{ \begin{matrix}⌈ \frac{N}{M} ⌉ & if N \geq M \\ ⌈ \frac{M}{N} ⌉ & if N < M\end{matrix} .$$

Example 26 is the one or more processors of Example 20, wherein the number of SSB-to-RO association pattern periods K is the same for any particular PRACH repetition number.

Example 27 is the one or more processors of Example 20, wherein the number of SSB-to-RO association pattern periods K is associated with the particular PRACH repetition number N, wherein a different N corresponds to a different K.

Example 28 is the one or more processors of Example 20, wherein ROs associated with the particular SSB in each RO group have the same frequency position.

Example 29 is the one or more processors of Example 20, the operations further including: obtaining one or more ROs configured with Frequency Division Multiplexing (FDM); and enabling frequency hopping within the ROs configured with FDM.

Example 30 is the one or more processors of Example 29, wherein the number of ROs configured with FDM and associated with the particular SSB is the same at different time instances.

Example 31 is the one or more processors of Example 30, the operations further including: dropping a RO having a larger index at a particular time instance, so that the number of ROs configured with FDM and associated with the particular SSB is the same.

Example 32 is the one or more processors of Example 20, the operations further including performing a density control of RO groups.

Example 33 is the one or more processors of Example 32, the operations further including selecting only a first RO group within the time period X used for multiple repetitions of PRACH transmission.

Example 34 is the one or more processors of Example 32, the operations further including providing a bitmap indicating one or more RO groups within the time period X used for multiple repetitions of PRACH transmission.

Example 35 is the one or more processors of Example 32, the operations further including: obtaining a ratio of the RO groups within the time period X used for multiple repetitions of PRACH transmission.

Example 36 is the one or more processors of Example 32, the operations further including obtaining one or more odd RO groups or one or more even RO groups within the time period X used for multiple repetitions of PRACH transmission.

Example 37 is the one or more processors of Example 20, wherein

$$Y = ⌈ K * \frac{M}{N} ⌉ .$$

Example 38 may include a method of performing operations of any one of Examples 20-37.

Example 39 may include a user equipment (UE), including: one or more processors; and one or more memory devices storing instructions that, when executed, cause the one or more processors to perform operations of any one of Examples 20-37.

Example 40 includes one or more processors of a base station, the one or more processors configured to perform operations for multiple Physical Random Access Channel (PRACH) transmissions, the operations including: identifying the number of RACH occasions (ROs) M associated with a particular Synchronization Signal Block (SSB) in a single SSB-to-RO association pattern period P; configuring a particular PRACH repetition number N, wherein the particular PRACH repetition number N is equal to or less than a maximum PRACH repetition number L; and determining the number of SSB-to-RO association pattern periods K within a time period X as a function of the number of ROs M and the particular PRACH repetition number N.

Example 41 is the one or more processors of Example 40, wherein

$$K = \{ \begin{matrix}⌈ \frac{N}{M} ⌉ & if N \geq M \\ 1 & if N < M\end{matrix} and X = K \times P .$$

Example 42 is the one or more processors of Example 40, the operations further including configuring one or more RO groups within the time period X, wherein at least one RO group is associated with the particular PRACH repetition number N, wherein the number of ROs in the at least one RO group is the same as the particular PRACH repetition number N.

Example 43 is the one or more processors of Example 40, wherein the particular PRACH repetition number N is the maximum PRACH repetition number L, the operations further including: configuring a single RO group within the time period X, wherein the number of ROs in the single RO group is the maximum PRACH repetition number L.

Example 44 is the one or more processors of Example 40, wherein the particular PRACH repetition number N is ½×the maximum PRACH repetition number L, the operations further including: configuring two RO groups within the time period X, wherein the number of ROs in each RO group is ½×L.

Example 45 is the one or more processors of Example 40, wherein the particular PRACH repetition number N is ¼×the maximum PRACH repetition number L, the operations further including: configuring four RO groups within the time period X, wherein the number of ROs in each RO group is ¼×L.

Example 46 is the one or more processors of Example 42, wherein when the single SSB-to-RO association pattern period P includes at least L ROs, K=1.

Example 47 is the one or more processors of Example 46, when K=1, the number of RO groups within the time period X is

$$⌈ \frac{M}{N} ⌉ .$$

Example 48 is the one or more processors of Example 42, the operations further including: determining a first starting RO position in a first time period X, wherein the first starting RO position is aligned with a radio frame 0; and determining a second starting RO position in a subsequent time period X, wherein the second starting RO position is the first starting RO position +K×association pattern period×C, where C is a natural number.

Example 49 is the one or more processors of Example 48, wherein the particular PRACH repetition number N is ½×the maximum PRACH repetition number L, the operations further including: providing two RO groups within the time period X, wherein the number of ROs in each RO group is ½×L; and determining a third starting RO position in a second RO group in the first time period X, wherein the third starting RO position is the first starting RO position+½ ×L×RO.

Example 50 is the one or more processors of Example 48, wherein the particular PRACH repetition number N is ¼×the maximum PRACH repetition number L, the operations further including: providing four RO groups within the time period X, wherein the number of ROs in each RO group is ¼×L; and determining a third starting RO position in a subsequent RO group in the first time period X, wherein the third starting RO position is the first starting RO position+¼×L×RO×m, where m=1, 2, or 3.

Example 51 is the one or more processors of Example 42, wherein the number of SSB-to-RO association pattern periods K is the same for any particular PRACH repetition number.

Example 52 is the one or more processors of Example 42, wherein the number of SSB-to-RO association pattern periods K is associated with the particular PRACH repetition number N, wherein a different N corresponds to a different K.

Example 53 is the one or more processors of Example 42, wherein ROs associated with the particular SSB in each RO group have the same frequency position.

Example 54 is the one or more processors of Example 42, the operations further including: configuring one or more ROs with Frequency Division Multiplexing (FDM); and enabling frequency hopping within the ROs configured with FDM.

Example 55 is the one or more processors of Example 54, wherein the number of ROs configured with FDM and associated with the particular SSB is the same at different time instances.

Example 56 is the one or more processors of Example 55, the operations further including dropping a RO having a larger index at a particular time instance, so that the number of ROs configured with FDM and associated with the particular SSB is the same.

Example 57 may include a method of performing operations of any one of Examples 40-56.

Example 58 may include a base station, including: one or more processors; and one or more memory devices storing instructions that, when executed, cause the one or more processors to perform operations of any one of Examples 40-56.

Example 59 includes one or more processors of a base station, the one or more processors configured to perform operations for multiple Physical Random Access Channel (PRACH) transmissions, the operations including: identifying the number of RACH occasions (ROs) M associated with a particular Synchronization Signal Block (SSB) in a single SSB-to-RO association pattern period P; configuring a particular PRACH repetition number N, wherein the particular PRACH repetition number N is equal to or less than a maximum PRACH repetition number L; configuring the number of SSB-to-RO association pattern periods K within a time period X; and determining the number of RO groups Y within the time period X as a function of the number of SSB-to-RO association pattern periods K, the number of ROs M associated with the particular SSB in a single SSB-to-RO association pattern period P and the particular PRACH repetition number N, wherein the number of ROs in each RO group is equal to the particular PRACH repetition number N.

Example 60 is the one or more processors of Example 59, wherein

$$Y = \{ \begin{matrix}⌈ K / ⌈ \frac{N}{M} ⌉ ⌉ & if N \geq M \\ K * ⌈ \frac{M}{N} ⌉ & if N < M\end{matrix} and X = K \times P .$$

Example 61 is the one or more processors of Example 59, wherein the number of SSB-to-RO association pattern periods K is configured through Radio Resource Control (RRC) signaling or System Information Block 1 (SIB1).

Example 62 is the one or more processors of Example 59, wherein the particular PRACH repetition number N is ½×the maximum PRACH repetition number L, the operations further including: determining the number of RO groups 2×Y within the time period X, wherein the number of ROs in each RO group is ½×L.

Example 63 is the one or more processors of Example 59, wherein the particular PRACH repetition number N is ¼×the maximum PRACH repetition number L, the operations further including: determining the number of RO groups 4×Y within the time period X, wherein the number of ROs in each RO group is ¼×L.

Example 64 is the one or more processors of Example 59, the operations further including: determining a first starting RO position of a first RO group in the time period X, wherein the first starting RO position is aligned with a radio frame 0; and determining a subsequent starting RO position of a subsequent RO group in the time period X, wherein the subsequent starting RO position is the first starting RO +Z×y, where y≤Y and y is a natural number, and

$$Z = \{ \begin{matrix}⌈ \frac{N}{M} ⌉ & if N \geq M \\ ⌈ \frac{M}{N} ⌉ & if N < M\end{matrix} .$$

Example 65 is the one or more processors of Example 59, wherein the number of SSB-to-RO association pattern periods K is the same for any particular PRACH repetition number.

Example 66 is the one or more processors of Example 59, wherein the number of SSB-to-RO association pattern periods K is associated with the particular PRACH repetition number N, wherein a different N corresponds to a different K.

Example 67 is the one or more processors of Example 59, wherein ROs associated with the particular SSB in each RO group have the same frequency position.

Example 68 is the one or more processors of Example 59, the operations further including: configuring one or more ROs with Frequency Division Multiplexing (FDM); and enabling frequency hopping within the ROs configured with FDM.

Example 69 is the one or more processors of Example 68, wherein the number of ROs configured with FDM and associated with the particular SSB is the same at different time instances.

Example 70 is the one or more processors of Example 69, the operations further including: dropping a RO having a larger index at a particular time instance, so that the number of ROs configured with FDM and associated with the particular SSB is the same.

Example 71 is the one or more processors of Example 59, the operations further including: performing a density control of RO groups.

Example 72 is the one or more processors of Example 71, the operations further including: selecting only a first RO group within the time period X used for multiple repetitions of PRACH transmission.

Example 73 is the one or more processors of Example 71, the operations further including: providing a bitmap indicating one or more RO groups within the time period X used for multiple repetitions of PRACH transmission.

Example 74 is the one or more processors of Example 71, the operations further including: configuring a ratio of the RO groups within the time period X used for multiple repetitions of PRACH transmission.

Example 75 is the one or more processors of Example 71, the operations further including: configuring one or more odd RO groups or one or more even RO groups within the time period X used for multiple repetitions of PRACH transmission.

Example 76 is the one or more processors of Example 59, wherein

$$Y = ⌈ K * \frac{M}{N} ⌉ .$$

Example 77 may include a method of performing operations of any one of Examples 59-76.

Example 78 may include a base station, including: one or more processors; and one or more memory devices storing instructions that, when executed, cause the one or more processors to perform operations of any one of Examples 59-76.

Example 79 may include an apparatus including logic, modules, or circuitry to perform one or more elements of the operations described in or related to any of Examples 1-17, 20-37, 40-56, and 59-76, or any other operations or process described herein.

Example 80 may include a method, technique, or process as described in or related to the operations of any of Examples 1-17, 20-37, 40-56, and 59-76, or portions or parts thereof.

Example 81 may include an apparatus including: one or more processors and one or more computer-readable media including instructions that, when executed by the one or more processors, cause the one or more processors to perform the method, techniques, or process as described in or related to the operations of any of Examples 1-17, 20-37, 40-56, and 59-76, or portions or parts thereof.

Example 82 may include a signal as described in or related to any of Examples 1-17, 20-37, 40-56, and 59-76, or portions or parts thereof.

Example 83 may include a datagram, information element (IE), packet, frame, segment, PDU, or message as described in or related to any of Examples 1-17, 20-37, 40-56, and 59-76, or portions or parts thereof, or otherwise described in the present disclosure.

Example 84 may include a signal encoded with data as described in or related to any of Examples 1-17, 20-37, 40-56, and 59-76, or portions or parts thereof, or otherwise described in the present disclosure.

Example 85 may include a signal encoded with a datagram, IE, packet, frame, segment, PDU, or message as described in or related to any of Examples 1-17, 20-37, 40-56, and 59-76, or portions or parts thereof, or otherwise described in the present disclosure.

Example 86 may include an electromagnetic signal carrying computer-readable instructions, wherein execution of the computer-readable instructions by one or more processors is to cause the one or more processors to perform the method, techniques, or process as described in or related to the operations of any of Examples 1-17, 20-37, 40-56, and 59-76, or portions or parts thereof.

Example 87 may include a computer program including instructions, wherein execution of the program by a processing element is to cause the processing element to carry out the method, techniques, or process as described in or related to the operations of any of examples 1-17, 20-37, 40-56, and 59-76, or portions or parts thereof. The operations or actions performed by the instructions executed by the processing element can include the operations of any one of Examples 1-17, 20-37, 40-56, and 59-76.

Example 88 may include a signal in a wireless network as shown and described herein.

Example 89 may include a method of communicating in a wireless network as shown and described herein.

Example 90 may include a system for providing wireless communication as shown and described herein. The operations or actions performed by the system can include the operations of any one of Examples 1-17, 20-37, 40-56, and 59-76.

Example 91 may include a device for providing wireless communication as shown and described herein. The operations or actions performed by the device can include the operations of any one of Examples 1-17, 20-37, 40-56, and 59-76.

The previously-described operations of Examples 1-17, 20-37, 40-56, and 59-76 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

1. An apparatus comprising:
one or more processors; and
memory storing instructions that, when executed, are configured to cause the one or more processors to perform operations for Physical Random Access Channel (PRACH) transmissions, the operations comprising:
identifying the number of RACH occasions (ROs) M associated with a particular Synchronization Signal Block (SSB) in a single SSB-to-RO association pattern period P;
determining a particular PRACH repetition number N, wherein the particular PRACH repetition number N is equal to or less than a maximum PRACH repetition number L; and
determining the number of SSB-to-RO association pattern periods K within a time period X as a function of the number of ROs M associated with the particular SSB in the single SSB-to-RO association pattern period P and the particular PRACH repetition number N.

2. The apparatus of claim 1, wherein
$$K = \{ \begin{matrix}⌈ \frac{N}{M} ⌉ & if N \geq M \\ 1 & if N < M\end{matrix} and X = K \times P .$$

3. The apparatus of claim 1, the operations further comprising:
obtaining one or more RO groups within the time period X, wherein at least one RO group is associated with the particular PRACH repetition number N,
wherein the number of ROs in the at least one RO group is the same as the particular PRACH repetition number N.

4. The apparatus of claim 1, wherein the particular PRACH repetition number N is the maximum PRACH repetition number L, the operations further comprising:
obtaining a single RO group within the time period X, wherein the number of ROs in the single RO group is the maximum PRACH repetition number L.

5. The apparatus of claim 1, wherein the particular PRACH repetition number N is ½×the maximum PRACH repetition number L, the operations further comprising:
obtaining two RO groups within the time period X, wherein the number of ROs in each RO group is ½×L.

6. The apparatus of claim 1, wherein the particular PRACH repetition number N is ¼×the maximum PRACH repetition number L, the operations further comprising:
obtaining four RO groups within the time period X, wherein the number of ROs in each RO group is ¼×L.

7. The apparatus of claim 3, wherein when the single SSB-to-RO association pattern period P includes at least L ROs, K=1.

8. The apparatus of claim 7, when K=1, the number of RO groups within the time period X is
$$⌈ \frac{M}{N} ⌉ .$$

9. The apparatus of claim 3, the operations further comprising:
determining a first starting RO position in a first time period X, wherein the first starting RO position is aligned with a radio frame 0; and
determining a second starting RO position in a subsequent time period X, wherein the second starting RO position is the first starting RO position+K×association pattern period×C, where C is a natural number.

10. The apparatus of claim 9, wherein the particular PRACH repetition number N is ½×the maximum PRACH repetition number L, the operations further comprising:
providing two RO groups within the time period X, wherein the number of ROs in each RO group is ½×L; and
determining a third starting RO position in a second RO group in the first time period X, wherein the third starting RO position is the first starting RO position+½×L×RO.

11. The apparatus of claim 9, wherein the particular PRACH repetition number N is ¼×the maximum PRACH repetition number L, the operations further comprising:
providing four RO groups within the time period X, wherein the number of ROs in each RO group is ¼×L; and
determining a third starting RO position in a subsequent RO group in the first time period X, wherein the third starting RO position is the first starting RO position+¼×L×RO×m, where m=1, 2, or 3.

12. The apparatus of claim 3, wherein the number of SSB-to-RO association pattern periods K is the same for any particular PRACH repetition number.

13. The apparatus of claim 3, wherein the number of SSB-to-RO association pattern periods K is associated with the particular PRACH repetition number N, wherein a different N corresponds to a different K.

14. The apparatus of claim 3, wherein ROs associated with the particular SSB in each RO group have the same frequency position.

15. The apparatus of claim 3, the operations further comprising:
obtaining one or more ROs configured with Frequency Division Multiplexing (FDM), wherein the number of ROs configured with FDM and associated with the particular SSB is the same at different time instances; and
enabling frequency hopping within the ROs configured with FDM.

16. (canceled)

17. The apparatus of claim 15, the operations further comprising:
dropping a RO having a larger index at a particular time instance, so that the number of ROs configured with FDM and associated with the particular SSB is the same.

18. A method for Physical Random Access Channel (PRACH) transmissions, the method comprising:
identifying the number of RACH occasions (ROs) M associated with a particular Synchronization Signal Block (SSB) in a single SSB-to-RO association pattern period P;
determining a particular PRACH repetition number N, wherein the particular PRACH repetition number N is equal to or less than a maximum PRACH repetition number L; and
determining the number of SSB-to-RO association pattern periods K within a time period X as a function of the number of ROs M associated with the particular SSB in the single SSB-to-RO association pattern period P and the particular PRACH repetition number N.

19. One or more non-transitory computer-readable media storing instructions that, when executed, cause one or more processors to perform the method of claim 18.

20. The apparatus of claim 1, wherein the apparatus comprises a user equipment (UE), and wherein determining the particular PRACH repetition number N comprises obtaining the particular PRACH repetition number N using a message received from a base station.

21. The apparatus of claim 1, wherein the apparatus comprises a base station, and wherein determining the particular PRACH repetition number N comprises configuring the particular PRACH repetition number N for transmission to a user equipment (UE).
